(19) United States
(12) Patent Application Publication
(10) Pub. No.: US 2006/0190522 A1
(43) Pub. Date: Aug. 24, 2006

(54) Method for controlling a computer

(76) Inventor: Mitsuhiro Nagata, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/344,125

(22) Filed: Feb. 1, 2006

(30) Foreign Application Priority Data
Feb. 18, 2005 (JP) 2005-041535

(51) Int. Cl. G06F 15/16

(52) U.S. Cl. 709/201

(57) ABSTRACT

A job scheduling system to execute plural jobs in an information system including plural computers for which an operation procedure is defined in the job flow format inputs a logical system configuration definition representing an architecture of the information system, sets a parameter for each job of the job flow according to the logical system configuration definition, and then executes the job flow. The system configuration definition defines a logical configuration of the information system according to data models to describe the system to thereby control the correspondence between defined logical servers and physical servers in the real world in a centralized manner. Using the information of the system configuration definition, the job scheduling system defines a parameter for each job of the job flow.

### INCORPORATION BY REFERENCE

The present application claims priority from Japanese application JP 2005-041535 filed on Feb. 18, 2005, the content of which is hereby incorporated by reference into this application.

### BACKGROUND OF THE INVENTION

The present invention relates to a system automation technique to control the execution of jobs, especially system operations on a plurality of computers.

There exists a job scheduling system in which jobs are executed according to a predefined job flow. In the system, the term “job” indicates a command or a script in which a procedure of commands or programs is described. Job scheduling systems are widely used to schedule and monitor typically “batch” jobs and also system operations in the enterprise system management. JP-A-2001-282551 describes such a job scheduling technique.

In a job scheduling system of this type, a user visually defines a job flow with like a setting screen view shown in FIG. 9. The user designates, for example, “Host20” as an identifier (ordinarily, a host name or an Internet Protocol (IP) address) of a computer, on which the command is executed, to an “execution host” setting item 91 in a property setting frame 84 of a job A1, “cmd1.exe” as an execution command to a “command” setting item 92, and “-h Host40” as a parameter to be passed to the command, to a “parameter” setting item 93. According to this example, when the job A1 is completely executed, a job A2 is executed, and when the job A2 is completely executed, a job A3 is executed.

Information systems using a computer network have been developed and broadly used today. Such an information system is constructed to provide some business service and usually managed and operated in that point of view as shown in FIG. 2. A system consists of a plurality of computers connected to a network. Each computer hosts an operating system and other programs, such as middleware corresponding to its use (e.g., an application server and a database management system), application programs and so on.

Such an information system is typically managed by the execution of a series of operation commands and/or scripts including these commands. Moreover many of command series can be formalized and hence the system operations can be automatically controlled by a job scheduling system (i.e., an IT operations management tool).

The job scheduling system defines a job flow indicating an execution sequence of jobs and each job indicating which program is executed on which computer by what parameters.

However, although the job scheduling system has the competence to support the operating of an information system linked to a business service as mentioned above, the conventional one is not possible to define the job flow using terms or element associated with the business service nor the system architecture.

This depends on the variety and generality of commands themselves to be used by the job scheduling system. That is, most software, the main provider of such commands is a so-called program product for open and general purpose. Therefore, in its command signature (a command format), it is not possible to set a relationship with a specific business service and specific system architecture. Also it is likely that a plurality of software packages from different venders are used to construct a system and each of them provides operation commands with different level and interface.

Therefore, in the job scheduling system, even when the setting screen view of FIG. 9 includes an operationally sufficient function with GUI, the user needs to pay fully attention to the semantics of some computer in the related business service and/or the system architecture, when the user specify the computer identifier to the ‘execution host’ property or the ‘command parameter’ property at a job flow definition. This imposes a troublesome load onto the system developers who are in charge of defining a series of job flows.

In designing, for example, an information system of “E-shopping” service, the system architecture including the configuration of logical servers such as “application servers” or “database servers”. Inherently, when developing job flows for this system, it is also desired to use the terms of the system architecture defined for “E-shopping” service, for example, “the application server APS1 of E-shopping system”. However, in the present stage of art, it is required for the user to recognize that the computer identifier, that is physical information used in a job flow definition, corresponds to which logical server in the system architecture.

This is not merely a matter of the naming control. Also developing job flows of system operations, it is necessary in many cases to pay attention to the semantics of the target system such as the configuration, structure, and so on. For example, the same set of monitoring conditions for the platform and software should be delivered to the same type of logical servers such as ‘Web servers’ in the system. Therefore, users, developers of these system operations should consider the architecture of the target system.

These problems tend to be more troublesome with the prevalent of the hardware consolidation technologies applying blade server systems and/or Storage Area Networks (SAN), and the utility computing technologies by which hardware resources are reallocated on demand to the information systems according to the loads on them.

For example, computer works for some information system during the daytime is used for the other system in the nighttime. This may also change the sets of application servers by time to which the same monitoring conditions to be set. In this situation, it is difficult for the developers to prepare all possible operations scenario as job flows and also for the operators to control the job flows timely according to the changeable systems.

### SUMMARY OF THE INVENTION

It is therefore an object of the present invention to simplify the operation or operating management of computers.

Another object of the present invention is that by efficiently managing job flows, the system operations supported by those job flows can be efficiently carried out to thereby mitigate the load imposed on the users for the system operations.

To achieve the object according to the present invention, there is provided a job scheduling system in which an operations procedure of an information system including a plurality of computers is executed as a set of a plurality of jobs defined in a job flow format. In this job scheduling system, a definition of logical system configurations which means the architecture of the target system is inputted. On the basis of the definition of the logical system configurations, the job scheduling system interprets the logical information given in the job flow definition such as job command parameters and then executes it properly.

The system configurations definition defines a logical architecture of the information system based on a system modeling which describes the system elements, their types, and the structures such as associations or aggregations of the elements. Also the definition defines the mapping between the early defined logical information, that is system elements typically like logical servers and the physical information automatically collected or defined like physical servers in a real world. Due to this mapping definition, when hardware used in the information system is changed or modified, it is possible to cope with this change only by modifying the system configurations definition without changing many of the influenced job flow definitions.

Next, this job scheduling system allows to use the information of the system configurations definition when a user defines a job flow. Particularly, this information can be added as meta-information to the job defining properties such as an execution host and command parameters in the job flow definition. For example, a logical server such as “APS1, the application server of E-shopping system” is designated as a command execution host of some job. This enables users to define their job flows highly synchronized with system architecture.

As well, this meta-information approach totally controlled inside the job scheduling system does not require any constraints or rules to the command interfaces provided by respective software packages.

Finally, this job scheduling system executes the defined job flow on the basis of the system configurations definition. In the execution, according to the meta-information designated at job definition and the mapping definition between the logical servers and the physical servers in the system configurations definition, the execution host and the parameter are determined. In this processing, when there exist a plurality of execution hosts determined, the execution command of the job may be repeatedly executed on each execution host. As a result, the request like “the same setting is to be delivered at a time to all hosts of a type ‘application server’” which seems to take troublesome procedures can be easily defined and executed as a simple and hardware independent job flow.

As above, those job flows highly synchronized with the information system can be efficiently defined and managed by this job scheduling system. Therefore, the operation management of the can be efficiently achieved with this job scheduling system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram to explain a system configuration.

FIG. 2 is a block diagram to explain an example of an information system.

FIG. 3 is a diagram to explain a definition of logical configurations of a system.

FIG. 4 is a diagram to explain definition items to define a job flow.

FIG. 5 is a Problem Analysis Diagram (PAD) to explain processing of a manager.

FIG. 6 is a PAD to explain processing of job flow execution by a manager.

FIG. 7 is a PAD to explain processing of job execution by a manager.

FIG. 8 is a PAD to explain processing of an agent.

FIG. 9 is a diagram showing a screen view to define a job flow.

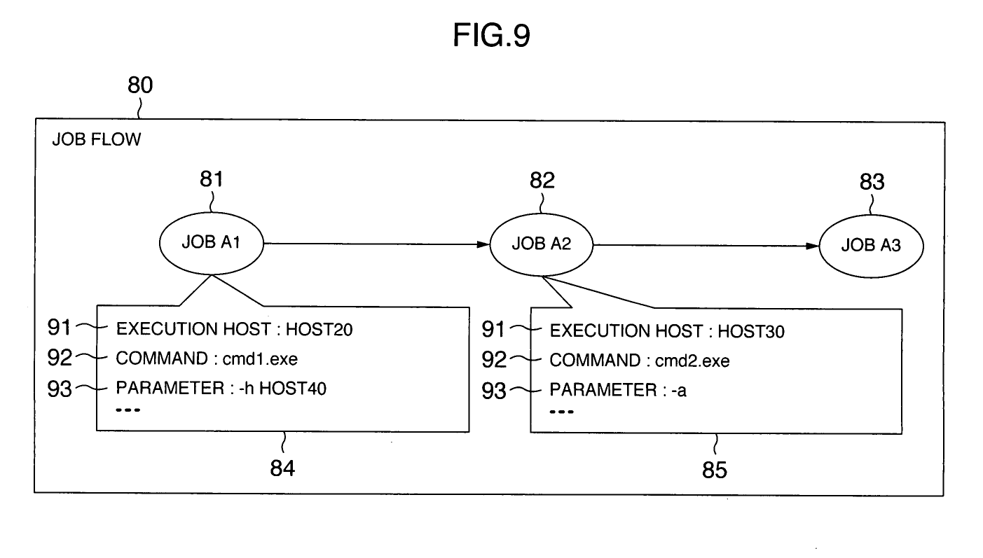

FIG. 10 is a diagram showing a table configuration to store job definition information.

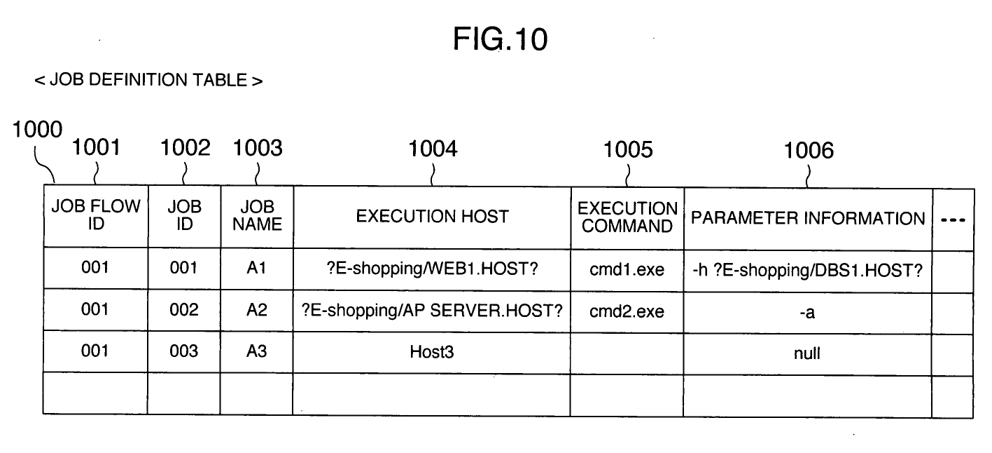

FIG. 11 is a diagram showing a configuration of a table to store logical configurations information of a system.

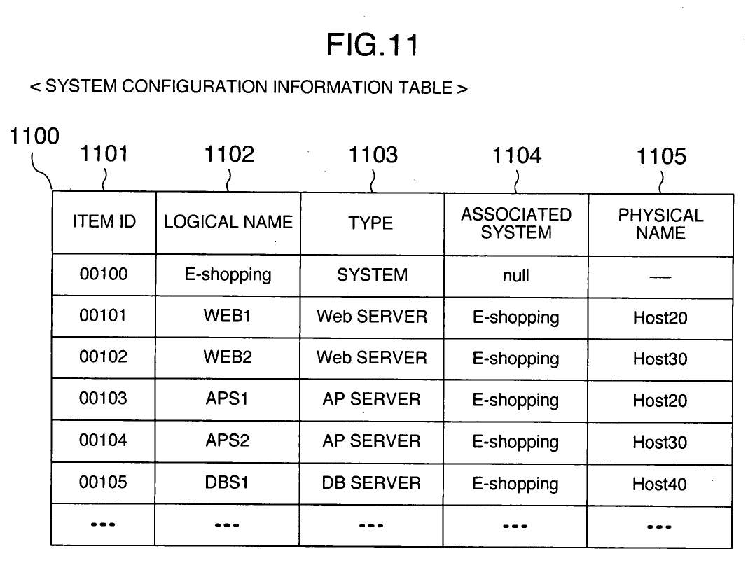

### DESCRIPTION OF THE EMBODIMENTS

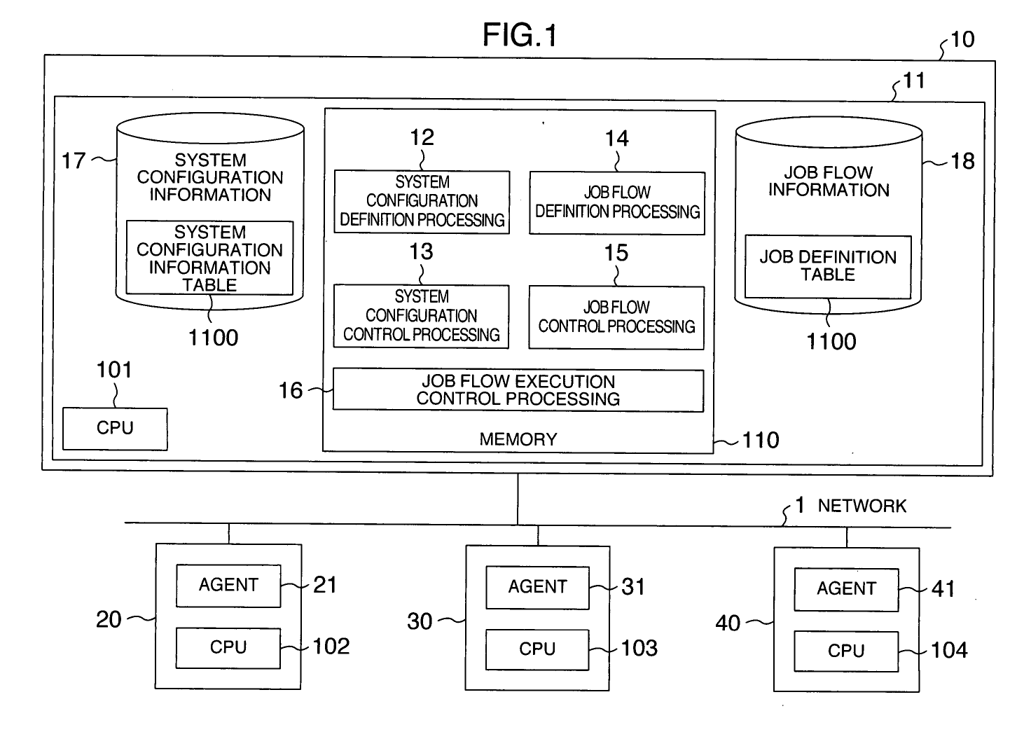

Referring now to the drawings, description will be given of an embodiment of the present invention. FIG. 1 shows a configuration of a job scheduling system, which will be described as an embodiment of the present invention.

<Job Scheduling System>

The system of FIG. 1 includes computers 10, 20, 30, and 40 connected via a network 1 to each other. Each computer includes a Central Processing Unit (CPU) and a memory including a program to implement the embodiment as below. On each computer, an operating system is running such that the job scheduling system executes jobs on the operating system according to a job flow designated in advance. This enables control of program execution in each computer.

Primary functions of the system is provided by a manager program (to be referred to as “manager” hereinbelow) 11 running on the computer 10 and agent programs (to be referred to as “agents” hereinbelow) 21, 31, 41, and 51 running respectively on the computers 20, 30, and 40.

The manager (program) 11 includes system configuration definition processing 12 for the user to define a logical configuration of a system, system configuration control processing 13 to control system configuration information 17 thus defined, job flow definition processing 14 for the user to define a job flow, job flow control processing 15 to control job flow information 18 defined as above, and job flow execution control processing 16 which analyzes the job flow, controls job scheduling, handles events, and controls and monitors execution of jobs and the job flow. The processing parts 12 to 16 are implemented by programs. The programs may also be achieved by hardware and/or objects.

The job flow information stored in the job flow control processing 15 includes information defining each job of the job flow, an execution sequence of the job, and information items set to an activation time of the job. The job definition information includes each command and a parameter thereof to be executed by the job and host information of a host to execute the command. The job flow execution control processing 16 monitors information of “day and time” outputted from a timer integrally disposed in the computer 10 and an execution state of a preceding job. At activation timing to activate a job defined in the job flow information 18, the processing 16 refers to the information 18 to identify an execution host, an execution command, and an associated parameter for the job. If the execution host is, for example, the computer 20, the job flow execution control processing 16 sends an indication of execution of the job to the computer 20. The agent 21 executes the command in response to the request from the manager 11. Depending on the job flow information 18, the execution host and the associated parameter includes information items of the system configuration information 17 defined by the user in the system configuration definition processing 12. In this situation, the job flow execution control processing 16 issues an inquiry to the system configuration control processing 13 such that the processing 13 determines an execution host and a parameter.

<System Configurations Definition>

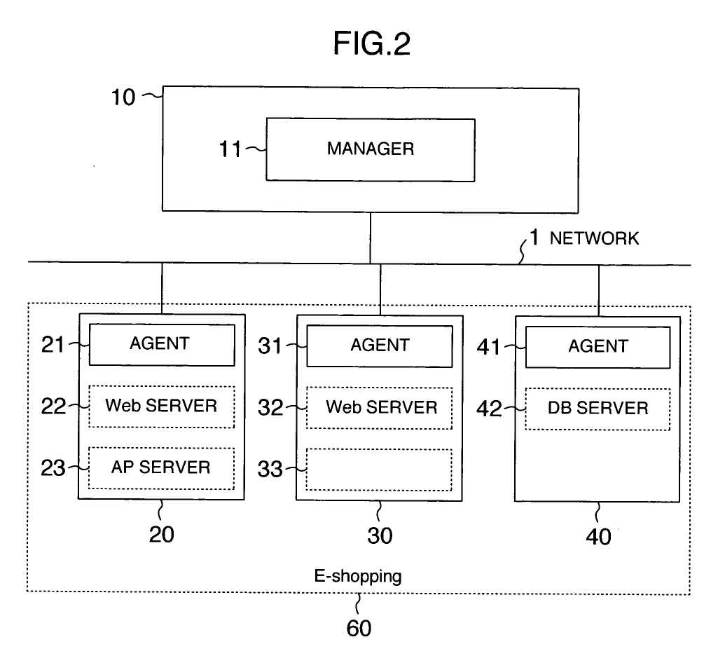

The agent of the job scheduling system is ordinarily installed in a computer to execute a business service information system. FIG. 2 shows an example of an information system 60 including the computers 10, 20, 30, and 40, specifically, a configuration example of “E-shopping”. The information system may include, in addition to the E-shopping system, several application systems.

The information system 60 is a system of a Web three-layer model. In the configuration, a Web server (Hypertext Transfer Protocol (HTTP) server) program 22 and an Application (AP) server program 23 are installed in the computer 20, the same Web server program 32 and the same AP server program 33 are installed in the computer 30, and a database management system 41 is installed in the computer 40. To automatically conduct a sequence of procedures for the operating management of the information system 60, the agents (agent programs) 21, 31, and 41 of the job scheduling system are installed respectively in the computers 20, 30, and 40 so that the manager 11 on the operating management computer 10 controls the agents.

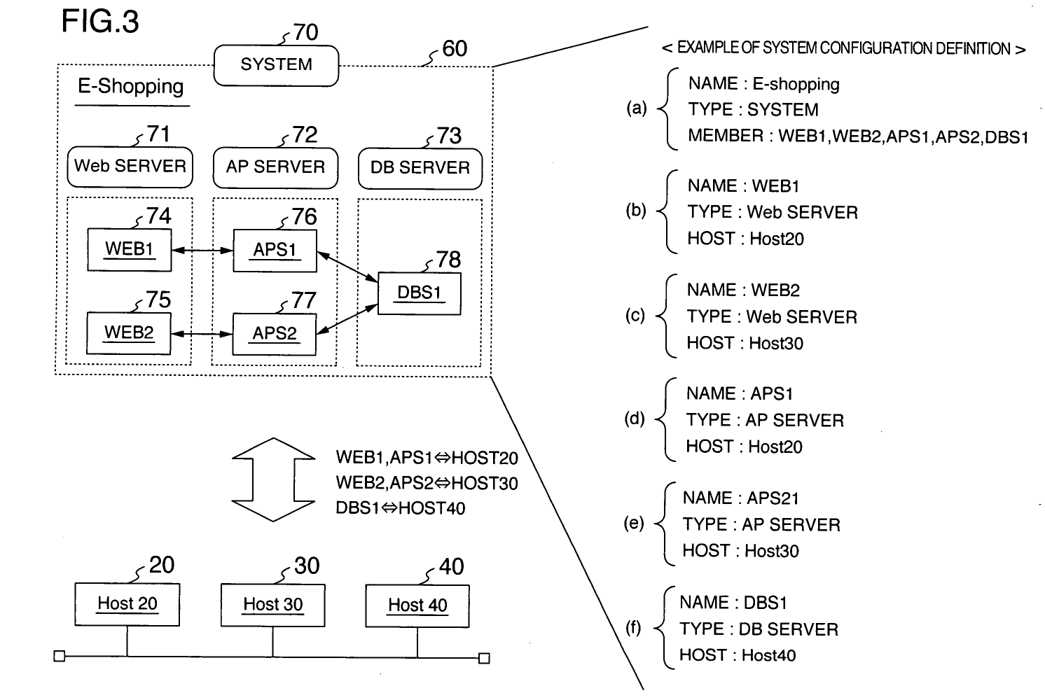

The system configuration definition processing 12 provides a user interface defining a logical configuration of the information system. FIG. 3 shows an example of a configuration definition of the information system 60 “E-shopping”. The processing 12 creates a model in which elements “system” and “logical server” necessary to describe a configuration of the system are treated as data items in a hierarchic configuration. As logical server models, the processing 12 provides “Web server”, “AP server”, and “DB server” to constitute a typical Web three-layer system.

To construct the E-shopping system 70 in the system configuration definition processing 12, the user defines logical servers by use of logical server types of the system. That is, a Web server 71 includes WEB1 74 and WEB2 75, an AP server 72 includes APS1 76 and APS2 77, and a DB server 73 includes DBS1 78. The user further defines that WEB1 74 and APS1 76 are installed in the computer 20, WEB2 75 and APS2 77 are installed in the computer 30, and DBS1 is installed in the computer 40. Two logical servers (logical computers) are assigned to each of the physical servers (physical computers) 20 and 30.

The definition information is represented in the form shown in (a) to (f) of FIG. 3. The information inputted in the system configuration definition processing 12 is stored in the system configuration information via the system configuration control processing 13. The system configuration information includes at least logical configuration information including information items of a system and constituent elements thereof and information of a correspondence between the logical constituent elements and the physical elements. The system configuration information is stored in a system configuration information table 1100.

In the embodiment, the data models to describe the system include only the system 70 corresponding to the manager 11 and the Web server 71, the AP server 72, and the DB server 73 as the logical servers. However, the models are not restricted by the embodiment. The models may also be expanded. For example, the logical servers include “load balancer” and “mail server” and the logical groups include groups such as “cluster group” to which the load balancer distributes load transparently.

<Job Flow Definition>

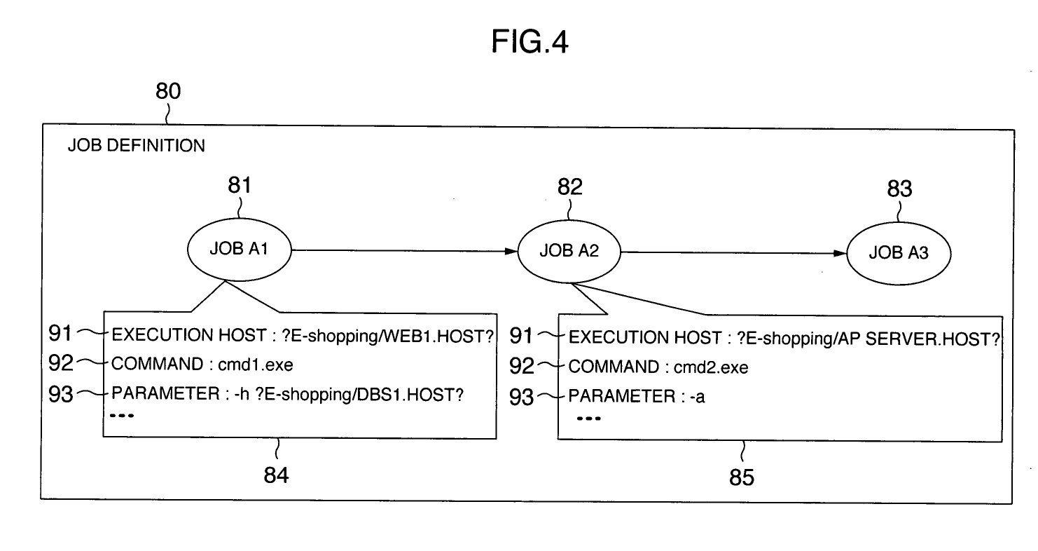

FIG. 4 shows a definition screen view 80 employed to define a job flow in the job flow definition processing 14. According to the definition of the job flow displayed on the screen view 80, a job A2 is executed after a job A1 and then a job A3 is executed after the job A2. In FIG. 4 in which the jobs A1 and A2 respectively correspond to objects 81 and 82. In property setting frames 84 and 85 respectively of the jobs A1 and A2 indicated respectively in association with the objects 81 and 82, there are disposed setting items 91 to 93 of “execution host”, “command”, and “parameter”. In this connection, the frames 84 and 85 may be displayed in another window. The setting item 91 of “execution host” is used to set an identifier of a computer to execute the job. The setting item 92 of “command” is used to set a command name to be activated by the job. The setting item 93 of “parameter” is used to set a parameter for activation of an associated command. Activation of the command results in creation of a process on the operating system. Incidentally, one job may include a plurality of processes.

The identifier of a computer set to the item 91 is conventionally a host name, an IP address, or a variable associated therewith. In the embodiment, it is possible to use the system configuration information 17 defined in the system configuration control processing 13 as meta-information including these identifiers. For example, a logical server can be employed in place of a physical server.

A value “?E-shopping/WEB1.host?” of the execution host setting item 91 in the property setting frame 84 of the job A1 is a variable receiving host information of the logical server “WEB1” as a member of the system “E-shopping”, the host information defined for an execution host in (b) of FIG. 3. When the job flow execution control processing 16 sends an inquiry to the system configuration control processing 13 at execution of the job A1, the conventional identifier “Host20” is assigned to the variable.

A value “?E-shopping/@APserver.host?” of the execution host setting item 91 in the property setting frame 85 of the job A2 is a variable receiving host (group) information of an execution host (execution hosts) of which the logical server type as a member of the system “E-shopping” is “AP server”, the host information defined for an execution host in (d) and (e) of FIG. 3. In the value, “@” indicates that the type can be received as a parameter. When the job flow execution control processing 16 sends an inquiry to the system configuration control processing 13 at execution of the job A2, the conventional execution host identifiers “Host20” and “Host30” are assigned to the variable. Resultantly, each of the computers 20 and 30 executes a predetermined command.

The meaning of each parameter varies between commands having received the parameter. Similar handling is possible for parameters receiving information contained in the system configuration information, e.g., a parameter receiving a computer identifier.

For example, “E-shoppin/DB1.host?” of the “-h” option in the parameter setting item 93 of the property setting frame 84 of the job A1 indicates that the variable receives host information of the logical server DBS1 as a member of the system E-shopping defined in FIG. 3. When the job flow execution control processing 16 sends an inquiry to the system configuration control processing 13 at execution of the job A1, the identifier Host40 of the computer 40 which is a conventional physical server is assigned to the variable.

In the embodiment, a variable such as the variable “?E-shopping/WEB1.host?” which refers to the system configuration information 17 is called “system definition variable”.

The information inputted in the job flow definition processing 14 is stored in the job flow information via the job flow control processing 15. Of the information, the information defining each job of the job flow is stored in the job definition table 1000. For example, the execution host setting item 91 is kept in an execution host column 1004, the command setting item 92 is kept in an execution command column 1005, and the parameter setting item 93 is kept in a parameter information column 1006.

<Processing of Manager>

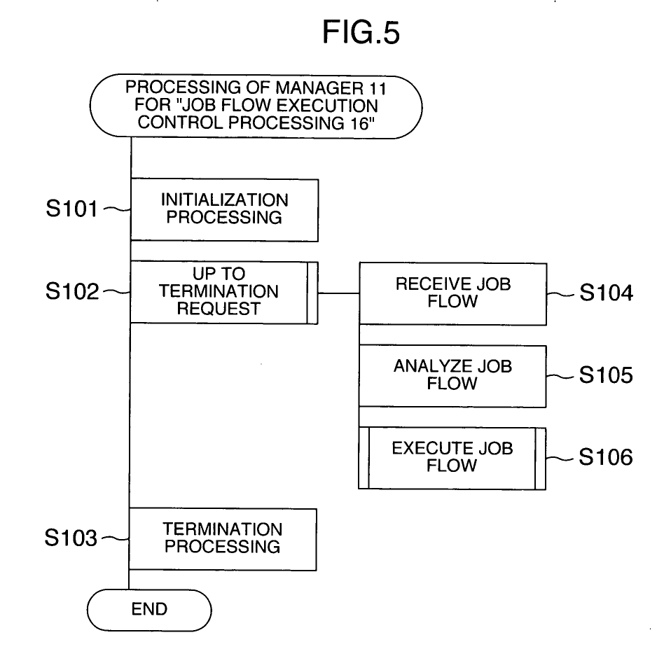

Next, description will be given of processing of the job scheduling system at execution of a job flow. FIG. 5 shows in a program analysis diagram the processing of the manager 11 (job execution control processing 16) at execution of a job flow. When a job flow set in advance is executed, the manager executes initialization processing S101 including initialization of a memory necessary for the processing 16. Thereafter, the manager 11 repeatedly executes the processes of job flow receiving processing S104, job flow analysis processing S105, and job flow execution processing S106 until an input of interruption for a termination indication is received. When the indication for termination is received, the manager 11 executes termination processing S103.

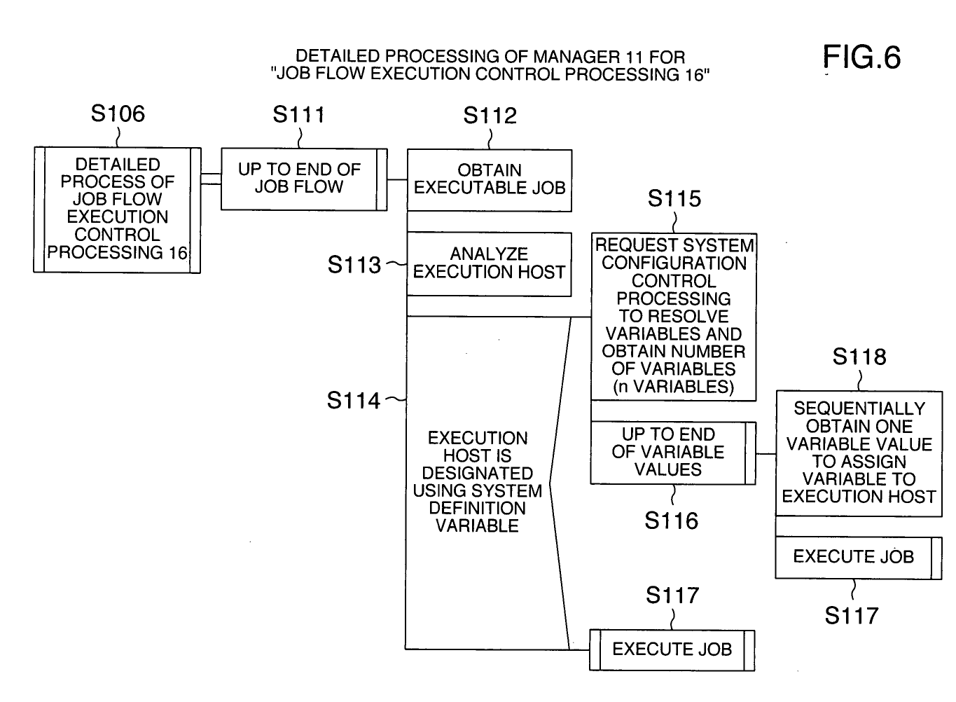

The program analysis diagram in FIG. 6 shows in detail the job flow execution processing S106 of the manager 11 shown in FIG. 5. The manager 11 selects an executable job (S112). An executable job is a job which is selected from the jobs controlled in an execution wait state by the job scheduling system and which is in a state satisfying an execution start condition, for example, termination of a preceding job or reception of an event. For the job, the manager 11 acquires and analyzes (S113) information of an execution host (1004) from the job definition table 1000 to determine whether or not the information includes the system definition variable (S114). Specifically, the manager 11 makes a check to determine whether or not the execution host information 1004 of the job flow definition includes a system definition variable sandwiched between question marks.

If such a system definition variable is present as a result of the check, the manager 11 requests the system configuration control processing 13 to resolve the variable (S115). The control processing 13 collates the system control information 17 under control thereof with the system definition variable to obtain a value of the variable and returns the value. For example, for the “?E-shopping/WEB1.host?”, the control processing 13 determines an element in the system configuration information table 1100 of which the belonging system 1104 is “E-shopping” and of which the logical name 1101 is “WEB1” to resultantly acquire “00101” as the element identifier (ID) of the element. The processing 13 determines a physical element 1105 of which the logical element (element ID) 1101 is “00101” and obtains the physical name 1105 of the element as “Host20” to return this value. For the “?E-shopping/DBS1.host?”, the control processing 13 determines an element in the system configuration information table 1100 of which the belonging system 1104 is “E-shopping” and of which the logical name 1101 is “DBS1” to resultantly acquire “00105” as the element identifier (ID) of the element. The processing 13 determines a physical element 1105 of which the logical element (element ID) 1101 is “00105” and obtains the physical name 1105 of the element as “Host40” to return this value. If N physical elements indicate “DBS1”, the processing is repeatedly executed N times to obtain a parameter including a converted physical element. The processing 13 sends the command with the parameter to the same physical server.

For the “E-shopping/@APserver.host?”, since “@” indicates a server type as described above, the control processing 13 obtains a set of logical element IDs “00103 and 00104” of which the belonging system 1104 is “E-shopping” and of which the type 1103 is “AP server”. For the respective logical elements (element IDs), the processing 13 obtains Host 20 and Host 30 respectively corresponding thereto and then returns the values. That is, a command and a parameter thereof is returned to each of Host 20 and Host 30.

The job execution control processing 16 receives the values of the system definition variable, i.e., a set of real hosts, and sequentially obtains a value therefrom to assign the value to an execution host (S118) to execute a job (S117). The processing is repeatedly executed for all values of the variable to be assigned to the execution host (S116).

In a case in which the execution host information does not include a system definition variable and the host information can be determined only by the value of the parameter, the job is executed using the information (S117).

The processing (S112 to S118) is repeatedly executed for all jobs contained in the job flow (S111).

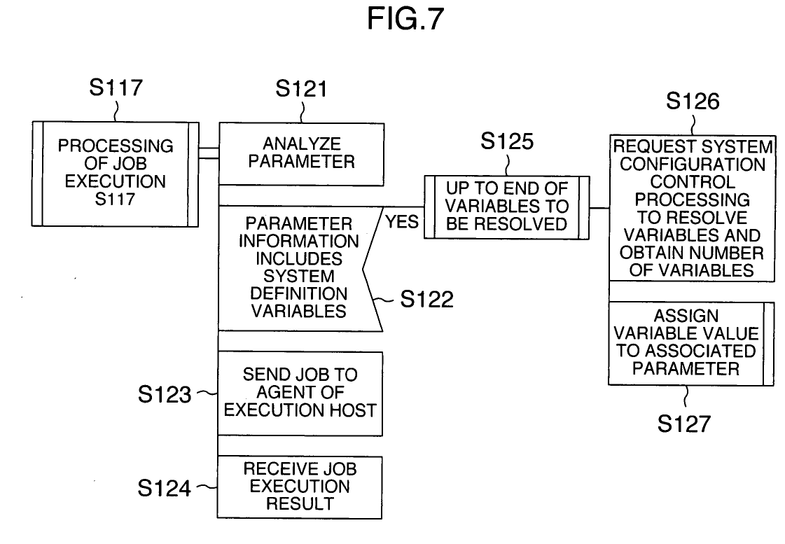

FIG. 7 is a program analysis diagram showing in detail the job execution processing (S117) of the job flow execution process shown in FIG. 6. After the execution host is determined, the manager 11 obtains and analyzes (S121) parameter information 1006 of the job from the job definition table 1000 to determine whether or not the parameter information 1006 includes a system definition variable (S122). Specifically, a check is made to determine whether or not the parameter information 1006 of the job flow definition includes a system definition variable enclosed by question marks “?”. Since two or more parameters are allowed for the job, the parameter information possibly includes a plurality of system definition variables. If the parameter information 1006 includes system definition variables, an inquiry is sent to the system configuration control processing 13 to resolve all system definition variables to resultantly acquire values of the variables (S126). The values are assigned to the associated parameters (S127). After all variables are resolved, determined parameter information is created (S125). The processing in which the control processing 13 collates the system configuration information 17 with the system definition variable to return a value of the system definition variable is almost the same as the processing (S115) of the execution host described above.

If the parameter information does not include a system definition variable, the value of the parameter can be regarded as the determined parameter information.

According to the parameter information and the execution command (1005) information attained from the job definition table 1000, execution job information is determined for the job. The manager 11 transmits the execution job information to the execution host agent 21, 31, 41, or 51 designated in advance (S123). It is assumed in the description of the embodiment that the programs and data for the job execution have been set up on the computer before the job execution is started. After the agent executes the job, the manager 11 receives a result of the job execution from the agent (S124).

<Agent Processing>

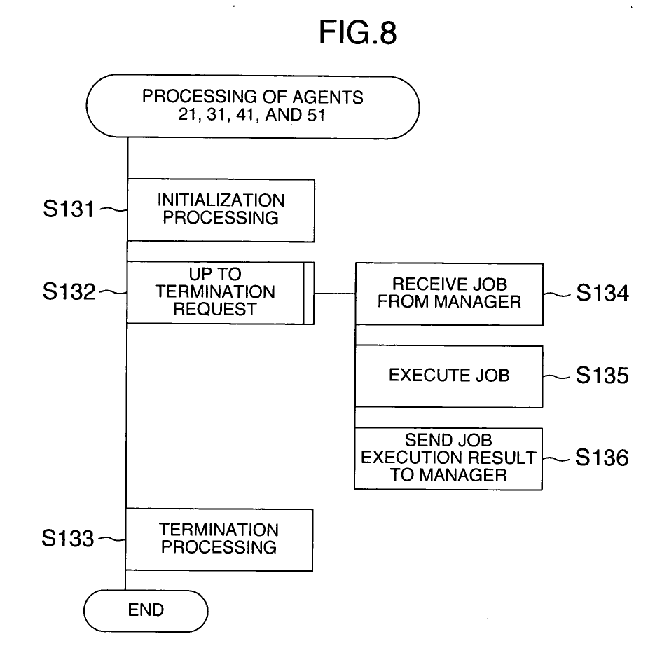

Referring now to the problem analysis diagram of FIG. 8, description will be given of the processing of the agents 21, 31, 41, and 51. After conducting the initialization processing (S131) such as initialization of a memory to be used in future, the agent 21, 31, 41, or 51 running on an associated execution computer receives the job execution information from the manager 11 (S134) to execute the job (S135) and then returns a result of the job execution to the manager 11 (S136). In this connection, “job execution” indicates execution of a command contained in the job execution information, by using a parameter also contained therein. Until an interruption (request) for a termination indication of each associated process (S132) is inputted, the processing of steps S134 to S136 is repeatedly executed. When the termination indication is received, the agent executes the termination processing (S133).

It is also possible that the program to conduct the job flow setting method are stored on a computer-readable storing or recording medium such that the program is loaded in a memory of a computer, which thereafter executes the program.

Although the description has been given of a job flow setting method in a job scheduling system according to the present invention, the embodiment has been described only for easy understanding of the present invention, and the present invention is not restricted by the embodiment. The present invention is intended to cover various changes and modifications and equivalent arrangements included within the spirit and scope of the claims.

The functions of the job scheduling system described above are only part of the entire functions thereof. The job scheduling system includes, in addition to the above functions, various functions according to configurations and modes of a system to which the present invention is applied. For example, there can be included an execution control function using job flow scheduling, a function to control repetitious execution, a function to start execution of a job by detecting a predetermined event, a function to control Graphical User Interface (GUI), a function to conduct communications using a network, and a function to conduct queuing operation for job execution control.

According to the present invention, the operating management of a system can be simplified.

It should be further understood by those skilled in the art that although the foregoing description has been made on embodiments of the invention, the invention is not limited thereto and various changes and modifications may be made without departing from the spirit of the invention and the scope of the appended claims.

1. A computer control method for use with a control computer which reads a command to execute a program stored in advance and which sends the command to a plurality of physical computers to thereby control the physical computers, wherein the control computer:
beforehand stores logical computer names respectively of the plural physical computers with a correspondence established between the physical computers and the logical computer names;
analyzes the command including the logical computer name of one of logical computers which executes the command; and
transmits the command thus analyzed to each of the physical computers corresponding to the logical computer name.

2. A computer control method for use with a computer system comprising a plurality of physical computers which each receives a command to execute a program and which each executes the program and a control computer which transmits the command to the physical computers to control the physical computers, wherein the control computer:
beforehand stores physical computer names respectively of the plural physical computers with a correspondence established between the physical computer names and computer types;
analyzes the command including a computer type of one of logical computers which executes the command; and
transmits the command thus analyzed to each of the physical computers corresponding to the computer type.

3. The computer control method according to claim 1, wherein if a parameter of the command includes the logical computer name, the parameter is converted into the plural physical computer names corresponding to the logical computer name and each of the commands thus converted is transmitted to the physical computers associated with the physical computer names.

4. The computer control method according to claim 2, wherein if a parameter of the command includes the logical computer name, the parameter is converted into the plural physical computer names corresponding to the logical computer name and each of the commands thus converted is transmitted to the physical computers associated with the physical computer names.

5. A control computer which reads a command to execute a program stored in advance and which sends the command to a plurality of physical computers to thereby control the physical computers, comprising:
a module for beforehand storing logical computer names respectively of the plural physical computers with a correspondence established between the physical computers and the logical computer names;
a module for analyzing the command including the logical computer name of the logical computer which executes the command; and
a module for transmitting the command thus analyzed to each of the physical computers corresponding to the logical computer name.

6. A control program to be executed by a control computer which reads a command to execute a program stored in advance and which sends the command to a plurality of physical computers to thereby control the physical computers, comprising:
a step of beforehand storing logical computer names respectively of the plural physical computers with a correspondence established between the physical computers and the logical computer names;
a step of analyzing the command including the logical computer name of the logical computer which executes the command; and
a step of transmitting the command thus analyzed to each of the physical computers corresponding to the logical computer name.

7. A job flow setting method of setting a job flow for a job scheduling system which defines for an information system including a plurality of computers an operation procedure in a format of a job flow to execute the operation procedure, comprising the steps of:
inputting system configuration information representing a configuration of the information system;
inputting partial information of the system configuration information, as a parameter of a job included in the job flow; and
establishing at execution of the job flow a correspondence between the partial information contained in the parameter and physical information required to execute the job, according to the system configuration information.

8. The job flow setting method according to claim 7, wherein the system configuration information includes a correspondence relationship between logical resources and physical resources.

9. The job flow setting method according to claim 7, further comprising the step of receiving a type of the logical resources as a parameter to be inputted thereto.

10. The job flow setting method according to claim 8, wherein:
the logical resources are logical servers; and
the physical resources are physical servers.

11. The job flow setting method according to claim 9, wherein if the parameter is a type of the logical resources, a correspondence is established between at least one of the logical resources belonging to the type and each of the physical resources associated with the logical resource.

12. A job flow execution method for use with a job scheduling system which defines for an information system including a plurality of computers an operation procedure in a format of a job flow to execute the operation procedure, comprising the steps of:
keeping system configuration information representing a configuration of the information system, the system configuration information being inputted in advance; and
establishing at execution of each job according to the job flow a correspondence between partial information of the system configuration information and physical information required to execute the job, the partial information being beforehand inputted as a parameter of the job.

13. The job flow execution method according to claim 12, wherein the system configuration information also includes a correspondence relationship between logical resources and physical resources.

14. The job flow execution method according to claim 12, further comprising the step of receiving a type of the logical resources as a parameter to be inputted thereto.

15. The job flow execution method according to claim 13, wherein:
the logical resources are logical servers; and
the physical resources are physical servers.

16. The job flow execution method according to claim 12, wherein if the parameter is a type of the logical servers, the job is executed by physical servers corresponding to at least one of the logical servers belonging to the type.

17. A computer-readable storing medium having stored a program to execute the job flow setting method according to claim 7.

18. A computer-readable storing medium having stored a program to execute the job flow executing method according to claim 12.
